(19) United States
(12) Patent Application Publication
(10) Pub. No.: US 2020/0166242 A1
(43) Pub. Date: May 28, 2020

(54) HEATING DEVICE AND METHOD FOR PRODUCING SUCH A HEATING DEVICE

(71) Applicant: Webasto SE, Stockdorf (DE)

(72) Inventors: MARTIN ZOSKE, Stockdorf (DE); MICHAEL SCHWANECKE, Stockdorf (DE); VOLODYMYR ILCHENKO, Stockdorf (DE); BENGT MEIER, Stockdorf (DE); CHRISTOPH JÖRG, Stockdorf (DE); VITALI DELL, Stockdorf (DE); NIKOLAUS GERHARDT, Stockdorf (DE)

(21) Appl. No.: 16/610,791

(22) PCT Filed: May 23, 2018
(86) PCT No.: PCT/EP2018/063497

§ 371 Date: Nov. 4, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 045.8

(51) Int. Cl. F24H 3/04; F24H 1/10; H05B 3/14

(52) U.S. Cl. CPC F24H 3/0429; F24H 1/103; F24H 3/04; H05B 3/146; H05B 2203/017; H05B 2203/02; H05B 2203/021; H05B 2203/023; F24H 2250/04

(57) ABSTRACT

A method for producing an electric heating device, preferably liquid or air heating device, in particular for a motor vehicle, wherein at least one first conductive polymer layer which contains a first polymer component and a first conductive component, in particular carbon component, is applied to an, in particular, insulating, first substrate in order to form a first heating element and is crosslinked there by means of radiation.

### CROSS-REFERENCE TO RELATED APPLICATIONS

This application represents the national stage entry of PCT International Patent Application No. PCT/EP2018/063497 filed on May 23, 2018 and claims priority to German Patent Application No. DE 10 2017 111 373.8 filed May 24, 2017, German Patent Application No. DE 10 2017 111 378.9 filed May 24, 2017, German Patent Application No. DE 10 2017 115 148.6 filed Jul. 6, 2017, and German Patent Application No. DE 10 2017 121 045.8 filed Sep. 12, 2017. The contents of each of these applications are hereby incorporated by reference as if set forth in their entirety herein.

### DESCRIPTION

The disclosure relates to a heating device, in particular a liquid or air heating device, preferably for a vehicle, preferably motor vehicle, and to a method for producing such a heating device.

Electric heating devices, in particular liquid or air heating devices (in particular those which are used in mobile applications), are generally based on ceramic heating elements having a comparatively heavily temperature-dependent electrical resistor through which self-regulation of the heat output is made possible. Said resistors are conventionally ceramic PTC elements (PTC stands for Positive Temperature Coefficient). They are generally connected to heat transfer surfaces made of aluminium sheet and are also electrically contacted via same. A PTC element comprises a PTC resistor, i.e. a temperature-dependent resistor having a positive temperature coefficient which conducts the electric current better at low temperatures than at high temperatures.

Disadvantages of conventional heating devices having ceramic PTC elements include, inter alia, complicated production due to comparatively complicated manufacturing of the heat exchanger and the installation of the ceramic elements, a conventionally necessary sorting of the ceramic elements because of manufacturing tolerances, a comparatively unfavourable power density in a heating element and heat exchanger assembly because of local heat generation, a comparatively great restriction of a maximum heating capacity because of a thickness of the PTC material (due to a limited dissipation of heat from the ceramic) and a comparatively high risk of short circuiting, in particular because of a small geometrical distance between components having a high voltage difference.

It is the object of the disclosure to propose a method for producing a heating device, in particular a liquid or air heating device, in which an operationally efficient heating device can be produced in a simple manner. Furthermore, it is the object of the disclosure to propose a corresponding heating device, in particular a liquid or air heating device.

This object is achieved in particular by a method according to claim 1.

In particular, the object is achieved by a method for producing an electric heating device, in particular a liquid or air heating device, preferably for a motor vehicle, wherein at least one first conductive polymer layer which contains a first polymer component and a first conductive (filling) component, in particular carbon component, is applied to an, in particular insulating, first substrate and is crosslinked there by means of (ionizing or high-energy)-radiation.

A core concept of the disclosure resides in the use of basically known conductive coatings on a polymer basis for a vehicle heating device, in particular a liquid or air heating device, wherein the substrate serves in particular as a heat exchanger. The polymer layer is preferably designed in such a manner that it has a (strong) positive temperature coefficient (and therefore a certain self-regulating property). A large (actively) heatable surface can be realized by the polymer layer, and therefore a necessary surface temperature can be reduced with the overall heating capacity remaining the same and the overall construction space remaining the same. Nevertheless, at (maximum) surface temperatures of below 200° C., overall heating capacities of up to 4 kW and optionally therebeyond are therefore still conceivable (in conventional construction spaces for vehicle heating devices, in particular motor vehicle heating devices).

It has also been recognized that comparatively low maximum temperatures permit the use of (comparatively cost-effective and simple to produce) plastics as substrate (carrier) and optionally as heat exchanger material. For example, the substrate (the carrier) can be produced cost-effectively and optionally in one part by an injection mould method, for example from temperature-resistant plastic, such as polyethylene (PE) and/or polypropylene (PP) and/or polyetheretherketone (PEEK) and/or optionally (short-) fibre-reinforced polyamide (for example PA-GF).

The (respective) substrate can comprise a film or can consist of such a film.

According to a further core concept of the disclosure, the polymer component is preferably crosslinked by ionizing (high-energy) radiation. The stability and service life of the polymer layer can thereby be improved (significantly), which is a particularly important prerequisite for use in an electric heating device, in particular in a liquid or air heating device. Radiation crosslinking is basically also known from the prior art (see, for example, WO 2014/188190 A1 or U.S. Pat. No. 8,716,633 B2). However, specifically in the present context, it has been shown that radiation crosslinking is particularly advantageous in the use of an electric heating device. In general, the properties of the polymer layer (for example a maximum use temperature, mechanical strength and/or service life) can thereby be improved significantly.

The method step of radiation crosslinking can basically be carried out as in WO 2014/188190 A1 or U.S. Pat. No. 8,716,633 B2. However, a person skilled in the art knows further possibilities for crosslinking via (high-energy) radiation.

In the embodiments, the (first or a further) polymer layer can be applied to the (first or correspondingly further) substrate by printing (imprinting) (for example by screen printing) and/or blade coating and/or spraying and/or dipping.

The radiation (for the crosslinking) preferably comprises electron radiation, γ-, β- and/or α-radiation. Electron radiation (for example as described in WO 2014/188190 A1 or U.S. Pat. No. 8,716,633 B2) or γ-radiation is particularly preferred.

In a specific embodiment, at least one second conductive polymer layer which contains a second polymer component and a second conductive (filling) carbon component, is applied to an, in particular insulating, second substrate and crosslinked there by means of (ionizing) radiation. Furthermore preferably, an intermediate space through which fluid is flowable in order to heat it up is formed between heating elements (which in each case comprise either the first conductive polymer layer and the first substrate or the second conductive polymer layer and the second substrate).

The substrate or the substrates can be manufactured at least in sections, preferably completely, from plastic, in particular a polymer, such as, for example, polyethylene and/or polypropylene and/or polyether ketone and/or polyamide and/or from an electrically insulating material and/or can be manufactured from a material which foams and/or melts at a temperature below 500° C., preferably 200° C.

The polymer layer or the polymer layers and/or a substance (in particular paste) for producing the respective polymer layer preferably comprises/comprise at least one polymer on the basis of at least one olefin; and/or at least one copolymer of at least one olefin and at least one monomer which can be copolymerized therewith, for example ethylene/acrylic acid and/or ethylene/ethyl acrylate and/or ethylene/vinyl acetate; and/or at least one polyalkenamer (polyacetylene or polyalkenylene), such as, for example, polyoctenamer; and/or at least one, in particular melt-deformable, fluoropolymer, such as, for example, polyvinylidene fluoride and/or copolymers thereof.

The conductive component(s) can comprise metal particles and/or metal fibres.

The conductive component(s), in particular the carbon in the carbon component(s), is preferably in particle form, in particular as soot particles, or as a scaffold (skeleton). The carbon can alternatively or additionally also be present as a carbon skeleton.

The carbon in the carbon component(s) can be in the form of soot and/or graphite and/or graphene and/or carbon fibres and/or carbon nanotubes and/or fullerenes.

The abovementioned object is furthermore achieved by an electric heating device, in particular a liquid or air heating device, in particular for a vehicle, preferably for a motor vehicle, preferably produced according to the above method, comprising at least one first heating element around which the fluid to be heated up can flow, wherein the first heating element has a, preferably electrically insulating, first substrate and at least one electrically conductive first polymer layer which contains a first polymer component and a first conductive component, in particular carbon component, wherein the polymer component is crosslinked by irradiation.

Preferably, at least one second heating element is provided, wherein the second heating element has a second substrate and at least one electrically conductive second polymer layer which contains a second polymer component and a second conductive component, in particular carbon component, wherein the second polymer component is crosslinked by irradiation, wherein an intermediate space through which fluid is flowable in order to heat it up is preferably formed between the heating elements.

The first and/or second heating element preferably extends/extend (at least substantially) along a fluid flow direction. Alternatively, the first and/or second heating element extends/extend in relation to the fluid flow direction at an angle, for example at an angle ≤90° and greater than 0°, in particular greater than 10°. At an extent at an angle (of greater than 0°) in relation to the fluid flow direction, preferably comparatively narrow heating elements can be used (i.e. heating elements, the width of which is comparatively small in relation to their length, for example is smaller than 0.2 times or smaller than 0.1 times). The width of the respective heating element can extend in the flow direction, and the length perpendicularly thereto. At least one of the heating elements (preferably a plurality or all of the heating elements) is/are preferably shorter in the flow direction than in a direction perpendicular thereto, for example 50% shorter. In particular a material thickness of the respective heating element should be regarded as the thickness.

The substrate or the substrates can be designed as a plate, in particular plastics plate, and/or can have a thickness of at least 0.1 mm, at least 0.5 mm, furthermore preferably at least 1.0 mm and/or at most 5.0 mm, furthermore preferably at most 3.0 mm. The respective thickness is in particular an average thickness or a thickness of the largest region with a constant thickness.

The first and/or second polymer layer and/or the substrate (or the substrates) can be at least substantially flat. If elevations (recesses) are provided, they can be less than 10% of an (average) thickness of the respective polymer layer or of the respective substrate.

At least three, preferably at least five heating elements, can optionally be provided with corresponding intermediate spaces.

A diameter of the intermediate space between the first and the second heating element can be greater than a thickness of the first and/or second heating element.

The abovementioned object is furthermore achieved by a method for operating a heating device of the above type or produced according to the above-described method, wherein fluid, in particular a liquid, such as, for example, water (in particular cooling water), or air, flows through the fluid channels and, in the process, is heated up.

The abovementioned object is furthermore achieved by the use of a heating device of the above-described type or produced according to the above-described method for heating up fluid, in particular a liquid, such as, for example, water (in particular cooling water) or air, in particular in a vehicle, preferably in a motor vehicle, furthermore preferably for a motor vehicle interior.

In embodiments, the polymer component can have a first polymer subcomponent on the basis of ethylene acetate (copolymer) and/or ethylene acrylate (copolymer) and/or can comprise a second polymer subcomponent on the basis of polyolefin, in particular polyethylene and/or polypropylene, and/or polyester and/or polyamide and/or fluoropolymer. The term “subcomponent” is intended to be used here in particular for differentiating between the first and second polymer subcomponent. The respective subcomponent can either partially or else completely form the polymer component. The ethylene acrylate can be ethyl-methyl acrylate or ethylene-ethyl acrylate. The ethylene acetate can be ethylenevinylacetate. The polyethylene can be HD (High Density) polyethylene, MD (Medium Density) polyethylene or LD (Low Density) polyethylene. The fluoropolymer can be PFA (copolymer of tetrafluoroethylene and perfluoropropylvinylester), MFA (copolymer of tetrafluorethylene and perfluorovinylester), FEP (copolymer of tetrafluorethylene and hexafluoropropylene), ETFE (copolymer of ethylene and tetrafluoroethylene) or PVDF (polyvinylidene fluoride).

In embodiments, the first polymer subcomponent can be formed as described in WO 2014/188190 A1 (as first electrically insulating material). The second polymer subcomponent can likewise be formed as described in WO 2014/188190 A1 (as second electrically insulating material).

Contacting of the (conductive, in particular carbon-containing) polymer layer can take place, for example, via (optionally curved) copper sheets and/or imprinted strip components which are in contact with the respective polymer layer.

The (optionally entire) component (heating device) can be lacquered to protect it from mechanical damage, moisture and/or short circuits.

The fluid to be heated can flow around the first heating element, which means in particular that the heating element forms a fluid channel (through which the fluid to be heated can flow) at least in sections.

In general, the electric heating device comprises one or more fluid channels for conducting the fluid to be heated. Said fluid channels can have, for example, a polygonal, in particular square, preferably rectangular cross section (perpendicular to a flow direction). Alternatively, one or more fluid channels with a (at least substantially) round, in particular circular, cross section can be present.

The polymer layer can be applied by application of a corresponding carbon heating paste. For example, said heating paste can be formed as proposed in Table I on page 11 of DE 689 23 455 T2.

The polymer layer can be applied (imprinted) to (onto) the substrate by a coating method and/or imprinting method. A curing step at an increased temperature (of, for example, above 120° C.) can optionally take place in a furnace. For the application, use can be made, for example, of a screen-printing method or else blade coating.

In general, the conductive (carbon-containing) polymer layer or a paste used for producing the conductive (carbon-containing) polymer layer can be formed as described in DE 689 23 455 T2. This applies in particular also to the production thereof and/or specific composition. For example, this also applies to possible binding agents (in particular according to page 4, second paragraph and page 5, first paragraph of DE 689 23 455 T2) and/or solvents (in particular according to page 5, second paragraph and page 6, second paragraph of DE 689 23 455 T2).

The substrate can be used simultaneously as a heat exchanger surface for heating up the fluid flowing past. Said surface can optionally also be enlarged by unevenness, in particular protrusions, such as ribs and/or fins on the substrate.

The substrate can be manufactured from an electrically insulating material.

The term “conductive” in respect of the conductive components of the heating device should basically be understood as an abbreviation for “electrically conductive”.

An electrically insulating material should be understood as meaning in particular a material which has (at room temperature of in particular 25° C.) an electrical conductivity of less than 10⁻¹S·m⁻¹ (optionally less than 10⁻⁸ S·m⁻¹). In a corresponding manner, an electrical conductor or a material (or coating) with electrical conductivity should be understood as meaning a material which has an electrical conductivity of preferably at least 10 S·m⁻¹, furthermore preferably at least 10³S·m⁻¹ (at room temperature of in particular 25° C.).

The substrate can be manufactured from a material which foams and/or melts at a temperature of below 500° C., preferably below 200° C.

The polymer layer can be contacted (electrically) by at least one metal structure, preferably an (in particular curved) metal sheet, preferably copper sheet, and/or metal strip and/or metal wire and/or metal grating, and/or by a metal layer and/or a metal foil. The metal structure can be applied by imprinting, vapour deposition, impressing or coating.

Alternatively or additionally, the metal structure (or corresponding electrodes) can be imprinted, for example, onto the substrate and/or the polymer layer.

The polymer layer(s) and/or a corresponding paste for the production thereof can comprise (as in particular a crystalline binding agent) at least one polymer, preferably on the basis of at least one olefin; and/or at least one copolymer of at least one olefin and at least one monomer which can be copolymerized therewith, for example ethylene/acrylic acid and/or ethylene/ethyl acrylate and/or ethylene/vinyl acetate; and/or at least one polyalkanamer (polyacetylene or polyalkylene), such as, for example, polyoctenamer; and/or at least one, in particular melt-deformable, fluoropolymer, such as, for example, polyvinylidenefluoride and/or copolymers thereof.

Furthermore, the polymer layer(s) can be cured in a furnace (at increased temperature).

In general, the polymer layer(s) can have a continuous surface (without interruptions) or can be textured, for example can have gaps (interruptions) or recesses.

The polymer layer(s) is/are preferably composed up to at least 5% by weight, preferably up to at least 10% by weight, even further preferably up to at least 15% by weight, even further preferably up to at least 20% by weight and/or by less than 50% of carbon (optionally without taking into consideration a carbon content of the polymer as such) or of the carbon component, such as, for example, the carbon particles.

An outline of the respective heating element (preferably or a plurality of all of the heating elements) can be polygonal, in particular square, preferably rectangular or oval, in particular elliptical, preferably round (circular).

At least one intermediate space (optionally a plurality of all of the intermediate spaces) can be bounded by (precisely) two or more heating elements.

A cross section of the intermediate space (in general or the fluid channel) can be polygonal, in particular square, preferably rectangular or oval, in particular elliptical, preferably round (circular).

A cross section within an intermediate space (fluid channel) can vary or be constant (over the length thereof). Cross sections of different intermediate spaces or fluid channels (i.e. intermediate spaces or fluid channels which are not formed by the same pair or the same group of heating elements) can also differ from one another or be the same. For example, cross sections of the intermediate spaces or fluid channels can be slot-shaped (in particular in the form of rectangular slots).

The respective polymer layer (at least one of the heating elements, preferably of a plurality or all of the heating elements) can be thinner (at least on average) than the corresponding substrate, for example by the factor 1.1; furthermore preferably by the factor 1.5.

The (respective) polymer layer is preferably a conductive layer having PTC behaviour.

The heating device, in particular liquid or air heating device, is preferably configured for operation in the low-voltage range (for example 100 volts or 60 volts).

The heating device, in particular liquid or air heating device, can be configured for operation with DC voltage and/or AC voltage and/or PWM.

The substrate or the substrates can be designed as a plate, in particular plastics plate, or as a film, in particular plastics film, and/or can have a thickness of at least 0.1 mm, preferably at least 0.5 mm, furthermore preferably at least 1.0 mm and/or at most 5.0 mm, furthermore preferably at most 3.0 mm. The respective thickness is in particular an average thickness or a thickness of the largest region having a constant thickness.

A (layer) thickness of the respective conductive (carbon-containing) polymer layer can be ≤1 mm, preferably ≤0.5 mm, even further preferably 0.2 mm.

The first and/or second polymer layer and/or the substrate (or the substrates) can be at least substantially flat. If elevations (recesses) are provided, they can be less than 10% of an (average) thickness of the respective coating or of the respective substrate.

A sum of the cross sections of fluid channels (in particular intermediate spaces between the heating elements) can be at least 2 times, preferably at least 4 times, as large as a sum of the cross sections of the heating elements (in particular as viewed transversely with respect to the fluid flow direction or transversely with respect to the width direction).

A filling material content, in particular the carbon content in the polymer layer of at least one heating element (preferably of a plurality or all or the heating elements) can be designed in such a manner that it permits a current flow (for example in particle form, with the particles correspondingly being in contact or lying close to one another).

The (respective) polymer layer is preferably in contact with the (respective) substrate over at least 20%, furthermore preferably at least 50%, even furthermore preferably at least 80% of a surface of the substrate facing the polymer layer. The substrate (which then serves as a further heat exchanger) can thereby be effectively transferred.

The (respective) substrate can be provided on both sides with a (conductive) polymer layer.

In particular when the heating device is realized as a water heating device, electrical insulation of the voltage- or current-conducting parts (in relation to the water) can be provided.

Further embodiments emerge from the dependent claims.

Overall, according to the disclosure, simple cost-effective production can be carried out by few (easily automatable) process steps and by means of cost-effective materials. A high heating capacity with little need for construction space is possible here. Furthermore, the fluid to be heated in particular undergoes a comparatively low pressure loss.

The disclosure will be described below with reference to an exemplary embodiment which will be explained in more detail with reference to the attached FIG, in which:

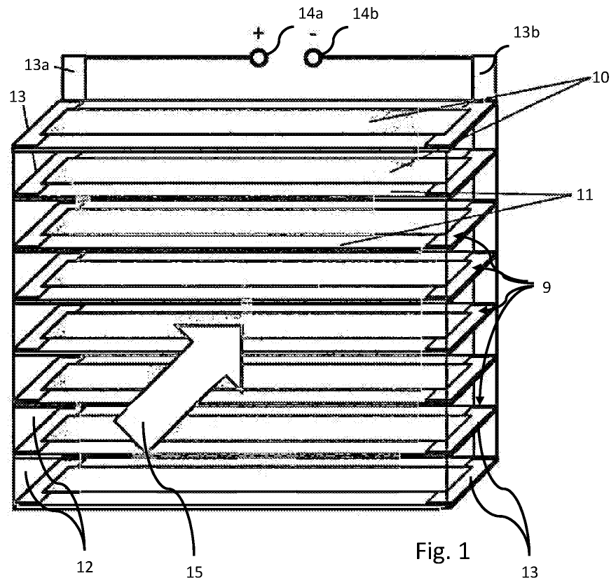

FIG. 1 shows a schematic oblique view of an electric heating device according to the disclosure.

The same reference numbers are used for identical and identically acting parts in the description below.

FIG. 1 shows an oblique view of an air heating device according to the disclosure. The air heating device comprises a multiplicity of heating elements 9 which each have a conductive polymer layer 10 and a substrate 11 to which the respective polymer layer 10 is applied. Overall (not compulsory), there are eight heating elements 9 in the present case. Corresponding intermediate spaces 12 (seven in the present case) are provided between the heating elements. The individual polymer layers 10 are connected to contact strips 13 (metal strips) arranged on the respective substrate 11. The contact strips 13 are in turn connected to (in the present case two) contact strips 13a, 13b (metal strips) connecting the heating elements 9 to one another. The contact strips 13a, 13b in turn permit contacting via contacts 14a, 14b. The air flow (during operation) is indicated by the arrow 15. The air flow therefore flows through the intermediate spaces 12 which extend parallel to the air flow. The polymer layers 10 shown in FIG. 1 are crosslinked by (ionizing) radiation, preferably electron radiation.

It should be pointed out at this juncture that all of the above-described parts are claimed as being essential to the disclosure as seen by themselves and in any combination, in particular the details illustrated in the drawings. A person skilled in the art is familiar with modifications thereof.

### LIST OF REFERENCE SIGNS

9 Heating element
10 Polymer layer
11 Substrate
12 Intermediate space
13 Contact strip
13a, 13b Contact strip
14a Contact
14b Contact
15 Arrow

1. Method for producing an electric heating device for a motor vehicle, wherein at least one first conductive polymer layer which contains a first polymer component and a first conductive component is applied to an insulating, first substrate in order to form a first heating element and is crosslinked there by radiation.

2. Method according to claim 1, wherein the polymer layer is applied to the substrate by printing and/or blade coating and/or spraying and/or dipping.

3. Method according to claim 1, wherein the radiation comprises electron radiation, γ-, β- and/or α-radiation.

4. Method according to claim 1, wherein at least one second conductive polymer layer which contains a second polymer component and a second conductive component is applied to an insulating second substrate to form a second heating element and is crosslinked there by radiation,
wherein an intermediate space through which fluid is to heat it up is formed between the heating elements.

5. Method according to claim 1, wherein the substrate or the substrates is or are manufactured at least in sections from a polymer and/or from an electrically insulating material and/or is or are manufactured from a material which foams and/or melts at a temperature below 500° C.

6. Method according to claim 1, wherein
the polymer layer or the polymer layers and/or a paste for producing the respective polymer layer comprises/comprise at least one polymer on the basis of
at least one olefin; and/or
at least one copolymer of at least one olefin and at least one monomer which can be copolymerized therewith,
and/or
at least one polyalkenamer (polyacetylene or polyalkenylene);
and/or
at least one fluoropolymer.

7. Method according to claim 1, wherein
the conductive component is present in particle form

8. Electric heating device, preferably liquid or air heating device for a motor vehicle comprising at least one first heating element around which the fluid to be heated up can flow, wherein the first heating element has an electrically insulating, first substrate and at least one electrically conductive first polymer layer which contains a first polymer component and a first conductive component, wherein the polymer component is crosslinked by irradiation.

9. Heating device according to claim 8,
wherein at least one second heating element is provided, wherein the second heating element has a second substrate and at least one electrically conductive second polymer layer which contains a second polymer component and a second conductive component, wherein the second polymer component is crosslinked by irradiation, wherein an intermediate space through which fluid is flowable in order to heat it up is formed between the heating elements.

10. Heating device according to claim 8, wherein first and/or second heating element at least substantially extends/extend along a fluid flow direction and/or extends/extend at an angle in relation to the fluid flow direction.

11. Heating device according to claim 8, wherein
the substrate or the substrates is or are designed as a plate, and/or
has/have a thickness of at least 0.1 mm.

12. Heating device according to claim 8, wherein the first and/or second polymer layer and/or the first and/or second substrate is/are at least substantially flat and/or the first and/or second polymer layer is/are in contact with the substrate over at least 20% of a surface of the substrate facing the respective polymer layer.

13. Heating device according to claim 8, wherein at least three heating elements are optionally provided with corresponding intermediate spaces and/or
a diameter of the intermediate space between the first and the second heating element is greater than a thickness of the first and/or second heating element.

14. Method for operating a heating device, preferably liquid or air heating device, according to claim 8, wherein fluid flows through the intermediate spaces and, in the process, is heated up.

15. Use of a heating device according to claim 8 or produced according to claim 1 for heating up fluid in a vehicle.

16. Method for operating a heating device according to claim 1, wherein fluid flows through the intermediate spaces and is heated up.

17. Method for operating a heating device according to claim 1, wherein the first conductive component is a carbon component.

18. Method according to claim 5, wherein the a polymer is polyethylene and/or polypropylene and/or polyether ketone and/or polyamide.

19. Method according to claim 7, wherein the particle form is soot particles, and/or as a carbon skeleton and/or in the form of soot and/or graphite and/or graphene and/or carbon fibres and/or carbon nanotubes and/or fullerenes.

20. Heating device according to claim 8, wherein the first and/or second polymer layer and/or the first and/or second substrate is/are at least substantially flat and/or the first and/or second polymer layer is/are in contact with the substrate over at least 80% of a surface of the substrate facing the respective polymer layer.
